(19) United States
(12) Patent Application Publication
(10) Pub. No.: US 2022/0343351 A1
(43) Pub. Date: Oct. 27, 2022

(54) DISTRIBUTED SCORING SYSTEM

(71) Applicant: sovanta AG, Heidelberg (DE)

(72) Inventor: Christian Heinrich, Walldorf (DE)

(21) Appl. No.: 17/238,313

(22) Filed: Apr. 23, 2021

(51) Int. Cl. G06Q 30/02; G06F 21/44; G06F 21/31

(52) U.S. Cl. CPC G06Q 30/0203; G06Q 30/0282; G06F 21/44; G06F 21/31; G06Q 2220/12

(57) ABSTRACT

Systems and methods are provided for computing user scores or ratings for an application program. The method comprises receiving a survey request from a scoring computer system and providing multiple instances of a survey template to a plurality of end-user-computers. A scoring computer system receives survey data from the plurality of end-user-computers and sends the survey data to the scoring computer system. The survey data is free of data allowing identification of individual end-users or end-user-computers. The scoring computer system computes a user experience score for the one application program as a function of the survey data and outputs a graphical representation of the computed score by the scoring computer system. The survey data is provided in a structure defined by one template, which allows the user experience of all end-users to be comparable.

### FIELD

The present disclosure relates to computer systems, and more particular to the field of computing user ratings or experience scores.

### BACKGROUND

US patent application US 2018/0024832 A1, the complete disclosure of which is incorporated herein by reference for all purposes, discloses a system for enhancing software applications based on user ratings. When a user downloads a software application from an online retail location, such as an “app store”, the user rates the application. NLP (natural language processing) techniques are then applied to correlate the features of the rated application with the user ratings. The rating of a user is public and subjective.

### SUMMARY

The present disclosure provides devices, systems and methods for computing a score for an application program. It is to be understood that both the foregoing general description and the following detailed description are exemplary and explanatory only and are not restrictive of the disclosure. Additional features of the disclosure will be set forth in part in the description which follows or may be learned by practice of the disclosure.

In one aspect, the invention relates to a method for computing a score for an application program. The method comprises providing a scoring computer system operatively coupled to a data repository comprising registration data of multiple customers and their software applications and providing a survey computer system comprising one or more survey templates. The data repository is protected against access by the survey computer system. The method further comprises receiving, by the survey computer system, a survey request from the scoring computer system. The survey request comprises an application-ID of one of the registered software applications. The survey computer system provides multiple instances of the one of the survey templates to a plurality of end-user-computers, and receives survey data from the plurality of end-user-computers via a network connection. The survey data is indicative of the user experience of end-users in respect to the one application program whose application-ID is comprised in the survey request. The survey data is provided in a structure defined by the template, and is sent from the survey computer system to the scoring computer system, whereby the survey data is free of data allowing identification of individual end-users or end-user-computers. The scoring system computes a score for the one application program as a function of the survey data received for at least the one application program. The score may be indicative of the aggregated user experience of the end-users in respect to the one application program. A graphical representation of the computed score may be generated by the scoring computer system.

Embodiments of the invention have the advantage that the user experience information is provided in a structured, comparable and hence less subjective data structure. Since the survey data indicative of the user experience is provided in a structure defined by the one template, the user experience of all end-users having received an instance of the same template are comparable. For example, a template instance can comprise predefined data entry elements such as radio buttons, check boxes or selectable lists which ensure that the survey data is provided in the form of structured data which can easily be processed and statistically analyzed by a computer.

A user's experience when interacting with an application program provided by a company often determines whether the application program is deemed suited for solving a particular task. However, user experiences are very subjective and often hard to acquire in a reproducible and comparable way. Furthermore, users may be reluctant to give honest feedback because it could be seen as an admission of difficulties in using a software application. Embodiments of the invention may enable end-users to provide feedback on the usability of a software application without disclosing their identity. Likewise, companies may not want to disclose which application programs they use or provide to their customers, and the desire to keep company-related information secret is an obstacle for an objective cross-company comparison of software-applications. Embodiments of the invention may allow an operator to compute comparative scores for similar software applications provided by different entities without disclosing the identity of the owner of a particular software application.

Embodiments of the invention may have the additional advantage that a particularly secure method for computing a user experience score for an application program is provided. None of the registered customers are able to determine the identity of the end-users having participated in the survey, because the survey computer system is configured to ensure that the survey data returned to the scoring computer system is free of data allowing identification of individual end-users or end-user-computers. This means that the survey data does not comprise IP-addresses, end-user names, or hardware-IDs of the end-user devices which would disclose the identity of the end-user. In addition, the data repository comprising customer-specific registration data is protected against access by the survey computer system. Also, no customer is allowed to access customer-registration data of other customers. Hence, the customers, e.g., companies owning one or more software applications, can be sure that sensitive customer-related data such as the identity of the customer, the size, economic strength and/or the number and identity of application programs owned by a customer is not disclosed to other customers or to an end-user.

Embodiments of the invention provide for a reproducible, less subjective, automatically evaluable survey method which is particularly secure. Embodiments of the invention reveal the strengths and weaknesses in the user experience of application programs and making the user experience measurable and provide a robust basis for decision-making in the context of software application acquisition and development.

According to some embodiments, the survey computer system comprises a plurality of templates and the ID of the template to be instantiated is specified in the survey request. Alternatively, the survey computer system comprises a mapping of application-IDs and template-IDs and the survey computer system analyzes the mapping in order to identify the template-ID of the template stored in association with the application-ID specified in the survey request. The identified template is one of the templates to be instantiated.

According to certain embodiments, the survey computer is configured to create, in response to receiving the survey request, a survey specific communication channel via which survey data can be received from a plurality of end-user devices that specifies user experience data selectively related to the application program whose application-ID is comprised in the survey request. For example, the survey-specific communication channel can be represented by a survey-specific URL which may comprise a survey-ID as one of one or more URL parameter-values.

According to one or more embodiments, the survey computer system is configured to store the application-ID comprised in the survey request in association with a survey-ID and is configured to provide the survey data obtained for this survey request to the scoring computer system together with the survey-ID. This allows the scoring computer system to compute a user experience score for a particular survey request and to perform multiple consecutive surveys for the same application program.

According to one or more embodiments, the survey data received by the survey computer system comprises sensitive end-user data, in particular an IP-address and/or user-ID of the end-user-computers. The survey computer system stores the received survey data such that the received survey data is protected against access by the scoring computer system. The survey computer system removes the sensitive end-user-data from the received end-user-data for providing anonymized survey data to the scoring computer system. The anonymized survey data is sent from the survey computer system to the scoring computer system. The survey computer system and the scoring computer system exchange data via a network connection, e.g., the internet.

For example, the survey computer system may receive survey data from the end-users together with an IP address and with an indication of the time of submitting the survey data. This data may be helpful for detecting various kinds of attacks, e.g., DOS attacks, or check whether the survey reaches all end-users in a given geographical region equally. Then, the IP addresses are deleted or at least they are not included in the survey data forwarded to the scoring computer system.

According to one or more embodiments, the computing of the score for the one application program comprises aggregating the totality of survey data currently comprised in the data repository which relates to the one application program and which was received via the requested survey, automatically identifying one or more other ones of the application programs being similar to one or more application program features and/or belonging to one or more other ones of the registered customers which are similar to the customer owning the one application program, and comparing the aggregated survey data of the one application program with the aggregated survey data of the one or more other identified application programs. The score is computed as a function of the result of the comparison. The score indicates the user experience of end-users in respect to the one application program relative to the user experience of end-users with the one or more identified other application programs.

For example, “similar” application programs can be programs configured to solve the same task, e.g., the control of a specific production process, the calibration of a specific measuring device, travel route planning, employee management, the handling of order processes, the simulation of the flow of liquids, etc. For example, the registration data of the customers may comprise application program metadata which specified the tasks solved by the application programs owned by this customer, and the scoring computer system can analyze the application program metadata in order to identify similar application programs.

For example, “similar” customers can be customers which are similar in respect to one or more properties such as the technical field in which a company operates, such as the number of employees of the company, the annual profit or annual turnover, the country or city where the headquarters of a company is located, etc.

According to certain embodiments, the scoring computer system is configured to perform the computing of the score in response to receiving survey data of one or more end-users from the survey computer system and/or in response to a repeatedly generated scheduler signal. The identification of the one or more similar application programs is performed solely based on a comparison of metadata and without decrypting any customer identification data. Preferably, the score computation is performed irrespective of whether the admin-user of the customer owning the one application program is currently successfully authenticated at a key store unit comprising a customer-specific cryptographic key of the said customer.

Embodiments of the invention have the advantage that a global, cross-customer and cross-application program user experience comparison can be performed without the need to disclose sensitive, identity-revealing information of the customers to an admin user having access to the totality of the data related to registered customers. For example, customers-specific, sensitive data being indicative of the identity of the customer can be stored in the data repository in an encrypted form, whereby preferably customer-specific keys are used. Some customer-related data, e.g., customer-metadata, may be stored in the data repository in cleartext form to allow the identification of similar customers without disclosing the customer's identity.

According to embodiments, the data repository comprises multiple sub-repositories respectively assigned to a different one of the registered customers. The data stored in the sub-repositories are isolated from each other. This means that no customer has access to registration data of other registered customers. Each sub-repository comprises: customer identification data of the customer to whom it is assigned, application-IDs of one or more applications owned by the said customer, application metadata of the one or more applications owned by the said customer, customer metadata of the said customer, the customer metadata being free of information allowing identification of the said customer and survey data gathered for the one or more application programs owned by the customer, the survey data being free of customer identification data.

Selectively the customer identification data in each of the sub-repositories is encrypted with a customer-specific cryptographic key. The survey data and the application metadata and the customer metadata is stored in cleartext form. The “customer identification data” of a customer can be, for example, name and/or address of a legal or natural person. The customer metadata may comprise, for example, a specification of the size of the customer (in terms of employees, supporters, etc.), technical field in which the customer operates, annual turnaround, annual profit, etc.

According to embodiments, the scoring computer system is operatively coupled to a data storage unit referred to as key store. The customer-specific cryptographic keys are stored in the key store. The key store is configured to grant the scoring computer system access to the cryptographic key of a particular customer only after a successful authentication of an admin-user of the particular customer at the key store. The key store is configured to deny the scoring computer system access to the cryptographic key of the particular customer automatically upon a log-out event of the admin-user from the key store.

This may further increase the security of sensitive customer-related information: there exist situations when at least the customer needs to have access to his or her data, e.g., in order to update an address or bank account number. In this case, the key score requires the admin-user of the respective customer to authenticate at the key store and allows the scoring system to access the decrypted customer-specific data only during a valid session with an authenticated admin-user of this customer. Once the admin-user logs out, the scoring computer system does not have access to sensitive, encrypted customer-related data. This will have the advantage that even the technical admin of the scoring computer system will not be able to access, compare or disclose sensitive customer-specific data and will not be able to determine the association between the identity of a customer and of customer-specific metadata. Hence, a particular secure system and method for cross-customer and cross-application comparison of user experience is provided.

According to certain embodiments, the method further comprises creating, by the scoring computer system, the survey request for one of the registered customers. In response to receiving the request, creating, by the survey-computer system, a URL being unique for the requested survey, sending the URL from the survey-computer system to the scoring computer system; and providing, by the scoring computer system, the URL directly or via the one of the registered customers for which the survey request was created to the end-users, in particular via a printout, an e-mail, a webpage or via an app on an end-user-device.

This embodiment has the advantage that it is not necessary to disclose the identity of the end-users or the contact addresses of the end user devices to the survey computer system. Rather, the survey computer system merely creates an URL. Preferably, the survey computer system stores this URL in association with a survey-ID of the requested survey. The URL is provided to the scoring computer system which can return the URL to the computer of the admin-user of the customer having requested the survey. Hence, neither the survey computer system nor the scoring computer system need to know the identity of the end-users. According to some embodiments, the URL comprises the survey-ID, e.g., in the form of a parameter-value pair comprised in the URL.

According to certain embodiments, the survey computer system or the scoring computer system is configured to encode the URL in a 2D code, in particular a matrix code. According to some embodiments, the survey template instance is a web-form provided via a network. The URL may be an URL of the web-form. According to embodiments, the method further comprises automatically decoding, by the end-user-computers, the URL in the provided 2D code, and instantiating the survey template in browsers of the end-user-computers by accessing the web form via the decoded URL.

This has the advantage that a large number of end-users can be reached and any user having the option to access the internet via a browser can participate in the survey. It is not necessary that the user installs a specific client program, it is not necessary that the user has installed or instantiated the application program of interest while taking part in the survey as the survey template instance is created independently of the application program of interest. Therefore, it is not necessary that the URL is provided from the admin-user of a customer to the end-users directly. For example, the 2D code can be provided as a print-out to the admin-user or the admin-user may receive the 2D code in electronic form and create the printout himself. Then, the admin-user may make a notice in the staff canteen, the notice containing the 2D code. Then, the staff/the end-users can easily take part in the survey simply by scanning the 2D code on the notice via their smartphone cameras. This may further increase the security and quality of the user experience score because the end-users can be sure that a URL provided via a notice on a public billboard is not personalized and cannot be traced back to a particular employee.

According to certain embodiments, the customers are companies and the data repository comprises customer-related metadata referred herein as “customer metadata”. The customer metadata comprises one or more of: the name of the customer (typically an organization, e.g., a company), the number of employees, the technical field in which the customer operates, the turnaround or profit in a given time period.

The data repository comprises application-related metadata of the application programs. The application-related metadata, also referred to as “application metadata”, comprises one or more of: the name of the application program, the type of the application, the version of the application, the program libraries used by the application, the number of end-users to be used by the application program, the programming language of the application program, the deployment-type of the application program, and the operating system required by the application program.

According to certain embodiments, the scoring system performs a cluster analysis for assigning the multiple application programs to different clusters. The application programs in the same cluster are similar in respect to their application metadata and/or belong to customers being similar in respect to the customer metadata. Then, the scoring computer system compares the score of the one application program selectively with the score obtained for the ones of the application programs being in the same cluster. The scoring computer system then outputs a result of the cluster-specific comparison. For example, the result can be used as the user experience score. Thus, the score may be computed as a cross-application program and as a cross-customer score which allows to compute a score that reproducibly indicates the usability of a particular piece of software in comparison to similar programs.

According to certain embodiments, the data repository comprises application metadata of the application programs. The application metadata comprises one or more of: the name of the application program, the type of the application, the version of the application, the program libraries used by the application, properties of the IT-environment of the application program (e.g. operating system, hardware components, etc.), the number of end-users to be used by the application program, the programming language of the application program, the deployment-type of the application program, the operating system required by the application program.

The scoring computer system comprises a trained machine-learning model. The trained machine learning model is a model having learned to correlate application metadata, in particular application metadata being indicative of technical properties of the application program, with respectively computed scores being indicative of end-user experience with the respective software application. The method further comprises using, by the scoring system, the trained machine learning model for predicting one or more software application modifications which will improve the end-user experience, and outputting the predicted improvement action.

For example, the trained machine learning model can be a model provided ty training a neural network, a support vector machine or other suitable machine-learning approaches. Embodiments of the invention may allow automatically determining that the use of two specific libraries in combination may reduce the quality of user experience, e.g., by reducing the reaction speed of an application program and/or by causing the application program to freeze or crash frequently. According to another example, the trained model may automatically determine that a particular application program is slower or less stable when instantiated on a particular operating system or computer system having a particular hardware component than on other operating systems or computer systems lacking this hardware component.

This embodiment is advantageous because the trained model may allow predicting which modification of the application program or of the IT-environment used for instantiating the application program should be modified in order to improve user experience. Software applications are often very complex and depend on a plurality of libraries. Even an extensive debugging process cannot guarantee that software is free of bugs, and some sporadically occurring bugs are very hard to identify and correct before the software program is rolled out. However, the comparative user experience of many thousand end-users and the knowledge how the user experience correlates with various technical parameters such as the libraries used or IT-environment properties may allow identifying and correcting bugs which cannot be detected by a developer, because it is impossible for a single person to foresee and test every combinatorically possible option of how to interact with a software and how to choose libraries and other technical settings of the software and its IT-environment.

According to certain embodiments, the predicted improvement action is selected from a group comprising: the adding, replacement or removal of a software library; the use of a different type or version of a DBMS used by the application program for storing or reading data; for example, a hierarchical DBMS could be used instead of a relational DBMS or vice versa; the use of a different hardware component, in particular network interfaces, device drivers and/or data storage devices; the use of a different webserver or application server for deploying and/or distributing the software application; the re-programming of the software application, in particular the optimization of specific source code sections, e.g., source code sections encoding the GUI of the application program.

Accordingly, the trained machine learning model according to embodiments of the invention may allow predicting actions and measures which can improve the software and in particular the user experience. For example, the model may output a message indicating to an admin-user of a customer that a particular software of this customer can be improved by using a particular type of DBMS, because similar applications have improved significantly after switching to this type of DBMS. Likewise, the predicted improvement action can suggest replacing a particular library or use a different monitor. In state-of-the-art system, software improvement was often based on manual change-log analysis which was often not able to clearly reveal the event or component having caused the error.

According to certain embodiments, the re-programming can be performed automatically or semi-automatically. For example, in case the user experience score indicates that a GUI is inconvenient to use because of too many required user-interactions, a software-optimization program may automatically replace all “selectable-list” GUI elements having less than four different selectable options with a radio button group or a check box group, thereby reducing the number of “clicks” a user has to perform for entering one or more selections. The re-programming of the software application can be part of a software development or improvement process, i.e., the process of restructuring existing computer code such that its external behavior is improved, e.g., made more reliable, responsive and/or intuitive.

According to certain embodiments, the release and/or deployment of a new version of a given software application automatically triggers the admin-user of a customer owning this software to request a new survey for the new version of the application program. In this case, the admin user can be a software program running on the admin computer and being in control of the deployment process of the new version of the application program. By comparing the usability scores obtained for different versions of the same application program, the developers can receive an objective, qualitative and preferably also quantitative feedback on whether the changes in the new software improved the usability and, if so, which aspects were improved the most.

According to one or more embodiments, the score is a combination of a set of sub-scores. Each of the sub-scores belongs to one out of 2-6, preferably 4 user-experience-categories. The method further comprises creating the graphical representation of the score in the form of a pie-chart. Each of the user-experience-categories is represented as a pie-chart-segment with a unique color. Each segment comprises a plurality of sub-segments having the same color as the segment comprising the sub-segment. The radius of each sub-segment is indicative of a respective one of the sub-scores.

According to certain embodiments, the survey computer system is configured to automatically send, in response to receiving survey data from any one of the multiple end-user-computers, the received survey data to the scoring computer system. The scoring computer system is configured to re-compute, in response to receiving the survey data, the score as a function of the received survey data, and to output a graphical representation of the re-computed score. This has the advantage that the computed score is always up-to date because the feedback information received from any individual end-user will automatically trigger a re-computation of the score.

According to one or more embodiments, the scoring computer system is configured to authenticate at the survey computer system. The survey computer system is configured to process survey requests only in case the request is received from an authenticated scoring computer system. For example, the authentication can be password-based, or can be based on a static IP-address or a hardware-ID of the scoring computer system. According to some embodiments, the scoring computer system's IP address or hardware-ID is stored in a storage medium operatively coupled to the survey computer system and the survey computer system is configured to receive survey requests and/or to send survey data only from/to a scoring computer system having an IP address or hardware-ID which is “known” to the survey computer system and is stored in the storage medium. This may increase security as only registered and trustworthy scoring computer system(s) are able to trigger template instantiation and are able to receive survey data from the survey computer system.

According to certain embodiments, the survey computer system is configured to authenticate at the scoring computer system. The survey computer system is configured to receive and process survey data only in case the request is received from an authenticated survey computer system. For example, the authentication can be password-based, or can be based on a static IP-address or a hardware-ID of the survey computer system. According to some embodiments, the survey computer system's IP address or hardware-ID is stored in a storage medium operatively coupled to the scoring computer system and the scoring computer system is configured to receive and process survey data only in case it is received from a survey computer system having an IP address or hardware-ID which is “known” to the scoring computer system and is stored in the said storage medium. According to some embodiments, the authentication may comprise a responsiveness-check. If the survey computer system is not able to correctly respond to a challenge provided by the scoring computer system within a predefined time period, the authentication is denied.

This embodiment may significantly increase security: as the survey computer system typically receives survey data from a large number of unknown, un-registered end user computers, there exists the risk of denial-of-service attacks. These types of attacks may indirectly also cause problems for the scoring computer system, e.g., because the survey computer system under attack may not be responsive to a query of the scoring computer system, thereby also blocking resources of the scoring computer system. Requiring authentication, in particular an authentication which includes a responsiveness-check, the security and robustness of the system may further be increased.

According to certain embodiments, at least some of the templates are customized specifically to the one of the application programs to whom they are assigned. The method further comprises: providing, by the scoring computer system an interface enabling an admin-user of the customers to create, modify and/or delete the ones of the templates being assigned to application programs owned by respective customer, receiving, by the scoring computer system, a newly created or modified survey template or a survey template deletion command from one of the admi-users via the interface, sending the newly created or modified survey template or the template deletion command from the scoring computer system to the survey computer system, and updating, by the survey computer system, the survey one or more templates in accordance with the received newly created or modified survey template or the template deletion command.

Typically, the same template will be used for all or at least the majority of application programs to increase the comparability of the received survey data. However, according to some embodiments, at least some templates are customized, e.g., for obtaining additional user experience information in respect to aspects which may only be relevant for a sub-set of software applications. For example, the quality of color management of a software may be of high relevance for the user experience of a drawing software, but of low relevance for an office application or a manufacturing process control software. So according to some embodiments, some templates may be customized to comprise additional questions, e.g., more detailed questions regarding the quality of color management selectively in a template used for obtaining user experience data for drawing application programs.

In a further aspect of the present disclosure, a computer system comprises a scoring computer system operatively coupled to a data repository. The data repository comprises registration data of multiple customers and their software applications. The system further comprises a survey computer system which comprises one or more survey templates. The data repository is protected against access by the survey computer system.

The survey computer system is configured to: (1) receive a survey request from the scoring computer system, the survey request comprising an application-ID of one of the registered software applications; (2) provide multiple instances of the one of the survey templates to a plurality of end-user-computers; (3) receive survey data from the plurality of end-user-computers via a network connection, the survey data being indicative of the user experience of end-users in respect to the one application program whose application-ID is comprised in the survey request, the survey data being provided in a structure defined by the template; and (4) end the survey data from the survey computer system to the scoring computer system, whereby the sent survey data is free of data allowing identification of individual end-users or end-user-computers.

The scoring computer system is configured to compute a score for the one application program as a function of the survey data received for at least the one application program, the score being indicative of the aggregated user experience of the end-users in respect to the one application program and output a graphical representation of the computed score.

In a further aspect, the invention relates to a computer-readable medium comprising instructions that when executed by a processor causes the processor to execute a method according to any one of the above embodiments.

In view of the wide variety of permutations to the embodiments described herein, this detailed description is intended to be illustrative only, and should not be taken as limiting the scope of the invention. What is claimed as the invention, therefore, is all such modifications as may come within the scope of the following claims and equivalents thereto. Therefore, the specification and drawings are to be regarded in an illustrative rather than a restrictive sense.

The accompanying drawings, which are incorporated in and constitute a part of this specification, illustrate several embodiments of the disclosure and together with the description, serve to explain the principles of the disclosure.

### BRIEF DESCRIPTION OF THE DRAWINGS

FIG. 1 is a flowchart of a method for computing a user experience score;

FIG. 2 is a block diagram of a distributed computer system for score computation;

FIG. 3 is a block diagram of the distributed computer system illustrating the data flow; and

FIG. 4 depicts a graphical representation of a user experience score.

### DETAILED DESCRIPTION

The present disclosure provides devices, systems and methods for computing a score for an application program. The embodiments and examples described herein are to be understood as illustrative examples of the invention. Further embodiments of the invention are envisaged. Although the invention has been described by way of example to a specific combination and distribution of software programs and computer systems, it is to be understood that any feature described in relation to any one embodiment may be used alone, or in combination with other features described, and may also be used in combination with one or more features of any other of the embodiments, or any combination of any other of the embodiments as long as these features are not mutually exclusive.

Accordingly, some embodiments of the present application are directed to a computer program product. Other embodiments of the present application include a corresponding computer-implemented method and software programs to perform any of the method embodiment steps and operations summarized above and disclosed in detail below.

Any software program described herein can be implemented as a single software application or as a distributed multi-module software application. The software program or programs described herein may be carried by one or more carriers. A carrier may be a signal, a communications channel, a non-transitory medium, or a computer readable medium amongst other examples. A computer readable medium may be a tape; a disc for example a CD or DVD; a hard disc; an electronic memory; or any other suitable data storage medium. The electronic memory may be a ROM, a RAM, Flash memory or any other suitable electronic memory device whether volatile or non-volatile.

Each of the different features, techniques, configurations, etc. discussed herein can be executed independently or in combination and via a single software process on in a combination of processes, such as in client/server configuration.

It is to be understood that the computer system and/or the computer-implemented method embodiments described herein can be implemented strictly as a software program or application, as software and hardware, or as hardware alone such as within a processor, or within an operating system or a within a software application.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

A “key store” as used herein is a data container configured to store cryptographic keys such that the use and/or access to any one of the keys stored therein is strictly controlled. Once keys are in the keystore, they can be used for cryptographic operations with the key material completely or partially remaining non-exportable. According to some embodiments, the key store offers facilities to restrict when and how keys can be used, such as requiring user authentication for key use or restricting keys to be used only in certain cryptographic modes. In particular, the keys are protected from unauthorized use. For example, a key store can mitigate unauthorized use of key material by allowing the scoring software to use the key of a particular customer for decrypting sensitive customer-specific data only within a session between the scoring computer system and an authenticated admin-user of this company and preferably after this admin-user has explicitly agreed to the decryption of the sensitive data. According to preferred embodiments, the keys, or at least the private keys, are never released by the key store. Rather, the encrypted data is entered into the key store and the key store uses the appropriate key to decrypt the encrypted data and to return the input data in decrypted form. This has the advantage that in case the scoring computer system is compromised, the attacker may be able to use the key store but cannot extract the key material in a different computer system. According to embodiments, the key store binds the keys stored therein to a secure hardware, e.g., a hardware security module (HSM). When this feature is enabled for a key, its key material is never exposed outside of secure hardware. A HSM typically comprises its own CPU, a secure storage and often also a true random-number generator. Often, an HSM comprises additional mechanisms to resist package tampering and unauthorized sideloading of apps. According to some embodiments, one or more of the following algorithms and key sizes are used by the key store for creating and using cryptographic keys: RSA 2048, AES 128 and 256, ECDSA P-256, HMAC-SHA256 and/or Triple DES 168

According to some embodiments, the key store lets the admin-user of a customer and/or the admin of the scoring computer system specify authorized uses of a customer-specific key when generating or importing the key. Once a key is generated or imported, its authorizations cannot be changed. Authorizations are then enforced by the key store whenever the key is used.

A “survey request” as used herein is a request to collect information about in a population of end-users, in particular information about the experience the end-users had when using and interacting with a particular application program.

An “admin computer” as used herein is a computer system assigned to a user referred herein as “admin” or “admin user”, whereby an admin user represents a customer having registered at the scoring computer system. Typically, the customer (and the admin user representing the customer) have obtained the right to initiate the creation of survey requests and/or to receive the computed user experience score of the application programs owned by the said customer. According to some embodiments, the scoring computer system may perform these steps only after a successful authentication of the admin user at the scoring computer system. The admin computer system can be, for example, a standard computer system, e.g., a desktop computer system or a portable computer system such as a notebook or tablet computer or smartphone.

An “end-user computer” as used herein is a computer system assigned to a user referred herein as “end-user”. The end-user is a user whose feedback in respect to the usability of a software application is to be obtained and analyzed in order to compute the user experience score. Typically, an end-user does not have permission to trigger the creation of a survey request or the computation of a user experience score. The end-user computer system can be, for example, a standard computer system, e.g., a desktop computer system or a portable computer system such as a notebook or tablet computer or smartphone.

An “application program” as used herein is a program or group of programs designed for end-users. Examples of an application include a program for controlling a manufacturing process, a program for simulating a technical process, e.g., fluid dynamics, a word processor, a spreadsheet, an accounting application, an email client, a media player, a file viewer, or a photo editor.

A “customer” as used herein is a digital representation of a natural or legal person, in particular a company.

A “data repository” as used herein is a logical data store which may be based on one or more physical data stores and which is used for storing a particular type of data, e.g., registration data. The data repository can be a file directory, a single file, a database operated by a database management system (DBMS) or the like.

The term “registration data” as used herein refers to data provided by a customer during the customers' registration at the scoring computer system. The registration data can comprise data being indicative of the identity of the customer, e.g., name and address, and may comprise customer-metadata and/or application metadata of one or more applications owned by the customer. The metadata may be provided during or after completion of the registration process.

An “survey computer system” as used herein is a computer system, in particular a server computer system. The survey computer system is configured to provide template instances to a plurality of end-user devices and to receive survey data from the end-user devices.

An “scoring computer system” as used herein is a computer system, in particular a server computer system. The scoring computer system is configured to receive survey data from the survey computer system and to compute a user experience score for a survey.

An “template” as used herein is a standardized file type, typically a non-executable file type, used by computer software as a pre-formatted example on which to base other files, especially surveys. Typically, the template instances and the survey data are exchanged via a network, in particular the internet.

The expression “computer system” as used herein is a machine or a set of machines that can be instructed to carry out sequences of arithmetic or logical operations automatically via computer programming. Modern computers have the ability to follow generalized sets of operations, called “programs”, “software programs”, “application” or “software applications”. These programs enable computers to perform a wide range of tasks. According to some embodiments, a computer system includes hardware (in particularly, one or more CPUs and memory), an operating system (main software), and additional software programs and/or peripheral equipment. The computer system can also be a group of computers that are connected and work together, in particular a computer network or computer cluster, e.g., a cloud computer system. Hence, a “computer system” as used herein can refer to a monolithic, standard computer system, e.g., a single server computer, or a network of computers, e.g., a clout computer system. In other words, one or more computerized devices, computer systems, controllers or processors can be programmed and/or configured to operate as explained herein to carry out different embodiments of the invention.

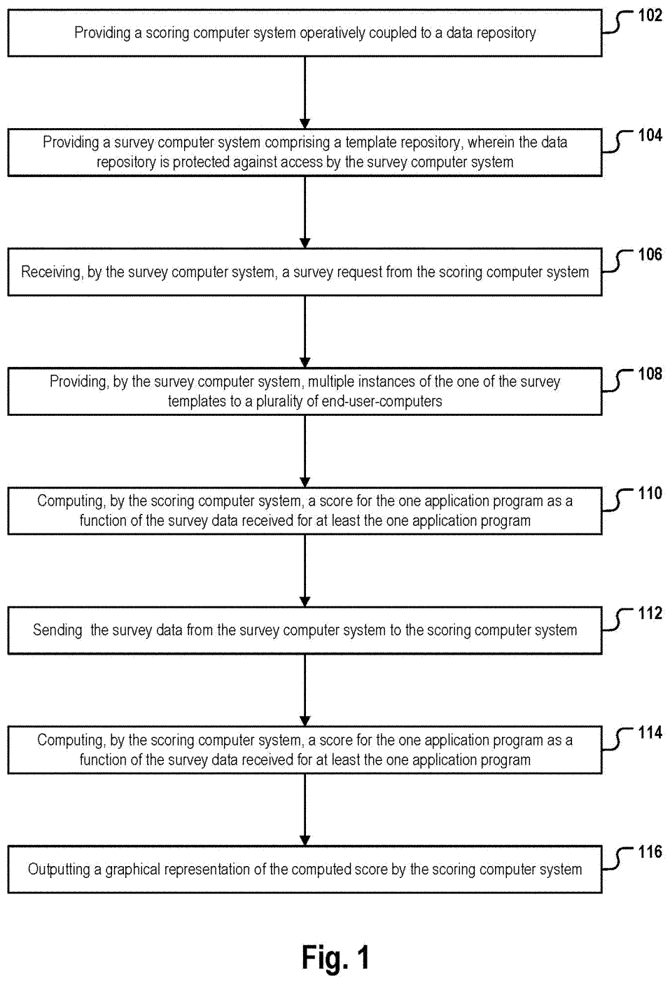

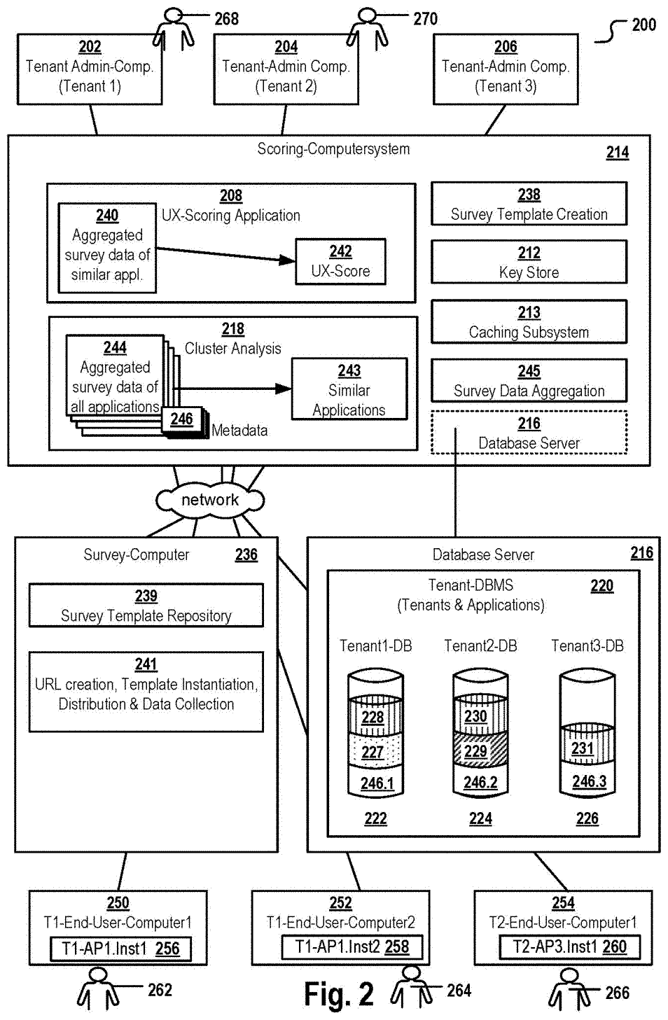

Referring now to FIG. 1, a flowchart is provided illustrating a method for computing a reproducible usability score for an application program according to one embodiment of the invention. According to some embodiments, the method is performed by components of a distributed computer system as depicted, for example, in FIG. 1. For the sake of simplicity, the method depicted in FIG. 1 will be described in the following by referring to elements of FIG. 2. However, according to other embodiments, the method can be performed by other computer systems which may comprise a different set of computer systems and/or other hardware or software components.

In a first step 102, a scoring computer system 214 is provided. The scoring computer system can be a monolithic computer system, e.g., a single server, or can be a distributed computer system, e.g., a cloud computer system and/or a virtualized computer system. The scoring computer system is operatively coupled to a data repository 220. The data repository comprises registration data of multiple customers having registered at the scoring computer system. Furthermore, the data repository comprises registration data and/or meter data of software applications owned by the registered customers. Each customer may own one or more application programs. The data repository 220 can be, for example, a DBMS hosted by a database server which is linked to the scoring computer system 214 via a network connection, e.g., an intranet or Internet connection. According to other embodiments, the data repository 220 can be an integral part of the scoring computer system, e.g., a DBMS instantiated on the same computer system as an application program 208, 218 used for performing a cluster analysis of customers and/or application programs and for computing the user experience score.

Next in step 104, the method comprises providing a survey computer system 236. The survey computer system comprises one or more survey templates 302, 304. For example, each template can be a file, e.g., an XML file or a JSON file, or a database record or any other type of data structure. According to preferred embodiment, each template has a format which allows editing by a user (e.g., XML or JSON, etc.). The data repository 220 is protected against access by the survey computer system. This means that sensitive customer-related information such as the customer's name and customer metadata such as company size, number of employees, number and type of software applications owned by the customer, user base and the like are not disclosed to the survey computer system.

Next in step 106, the survey computer system receives a survey request 310 from the scoring computer system 214. The survey request comprises application-ID of the one of the registered software applications for which a user experience score is to be obtained and computed.

In response to receiving the request, the survey computer system in step 108 provides multiple instances 306, 308 of the of the one of the survey templates which is assigned to the one of the application programs whose application-ID is comprised in the survey request and provides these instances to a plurality of end-user-computers 250, 252, 254. For example, the survey computer system can be configured to analyze the received survey request and to extract the application-ID and a request-ID comprised in the survey request. The survey computer system then identifies a template which is to be instantiated. For example, according to some embodiments, the survey computer system may comprise a single template which is used for generating survey template instances for all the application programs registered at the scoring computer system. According to other embodiments, the survey computer system may comprise different templates for different types of applications or may in some cases even comprise templates which are particular for a particular application program and/or which has been customized for a particular customer or application program. However, according to preferred embodiments, the same survey template is used for all application programs to ensure that the survey data received for the different application programs is comparable.

Typically, the survey computer system does not distribute the template instances directly to the end-users, because the survey computer system has no access to the data repository 220 or to any other data source being indicative of the name of the customer for whom the survey is to be conducted or being indicative of the identity of the end-users or the addresses of the end-user devices. For example, the survey computer system may be configured to create, in response to receiving the request, a survey-specific URL which allows any client device which is in possession of this URL to instantiate a survey template via a call of the URL. The survey computer system sends this URL to the scoring computer system 214 and the scoring computer system provides the URL directly or via an admin user 268, 270 and respective admin-devices 202, 204 to the end-users 262, 264, 266 and end-user devices 250, 252, 254.

Next in step 110 the survey computer system 236 receives survey data 316 from the plurality of end-user computers via a network connection. For example, the survey template instances can be HTML, forms which are downloaded via the Internet by the paralysis of the end-user devices. The end-users fill in survey data into the form and submit the survey data via the network back to the survey computer system. The survey data is indicative of the user experience of the end-users in respect to the one application program whose application ID is indicated in the survey request.

Next in step 112, the survey computer system sends the survey data to the scoring computer system 214. The sent survey data is free of data allowing identification of individual end-users and end-user computers. The survey data is free of data allowing identification of individual end-users or end-user computers such as end-user names or end-user-computer-IP-addresses. Hence, any end-user can be sure that his or her feedback data regarding usability of the software application of interest cannot be traced back. This may ensure that the end-user provides honest feedback and does not try to please expectations of the owner or provider of the software application program of interest (for which the score is to be computed).

Next in step 114, the scoring computer system computes a score 242 for the one application program whose usability score is to be computed. The score is computed as a function of the survey data received for at least the one application program of interest. According to preferred embodiments, the score is computed as a function of the survey data received for a plurality of different application programs owned by different customers. Preferably, only survey data of application programs which are similar to the application program of interest and/or survey data of application programs owned by customers which are similar to the customer owning the application program of interest are used for computing the usability score 242. For example, the application program of interest can be an application program for in-house organization and documentation of vacation days for a plurality of employees. In this case, according to one embodiment, only survey data obtained for application programs for organizing and/or documenting vacation days are used as input for computing the score value. According to some embodiments, the set of survey data used as input for the score computation is further limited to a survey data received for vacation planning programs used by customers which are similar to the customer owning the application program of interest, e.g., in respect to the number of employees, in respect to the technical field of operation, etc.

The computed score is indicative of the aggregated user experience of the end-users in respect to the one application program of interest. In case aggregated survey data of other applications is taken into account, the computed score is also indicative of the user experience relative to the user experience obtained for other application programs of other customers, in particular of similar and/or comparable application programs and customers.

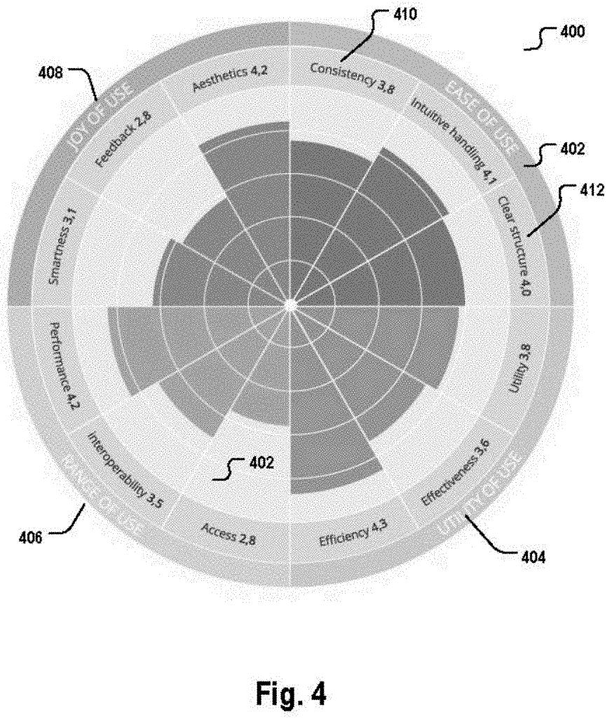

Next in step 116, the scoring computer system outputs a graphical representation of the computed score. For example, the output can be provided in the form of a printout or in the form of a graphical user interface element which is displayed via a display of the scoring computer system or via a display of a client computer system receiving the graphical representation of the score via a network. For example, the graphical representation of the score can be displayed in a browser of an admin computer 202, 204, 206 of an admin-user 286, 270 and can be provided by the scoring computer system via a network connection. An example for a graphical representation of a usability score is presented in FIG. 4.

FIG. 2 illustrates a block diagram of a distributed computer system 200 for computing a user experience score 242 4 an application program of interest. The system comprises at least a scoring computer system 214 and a survey computer system 236 connected to each other via a network connection, e.g., the Internet or an intranet. The scoring computer system and/or the survey computer system can be a monolithic computer system, e.g., a server computer system, or a distributed computer system, e.g., a cloud computer system or a part of a cloud computer system.

According to some embodiments, the system further comprises a data repository 220 operatively coupled to the scoring computer system. According to some embodiments, the system further comprises one or more admin computers 202, 204, 206 and/or one or more end-user computers 250, 252 and 254.

The scoring computer system comprises survey data aggregation functions 245 configured to aggregate the totality of survey data received from all end-users in respect to a particular survey request at a given time when the score is to be computed. For example, the aggregation can comprise computing the mean, min, max and/or median of a question-specific score based on the totality of survey data received from a plurality of end-users for a particular survey request. According to some embodiments, the application of survey data obtained for a particular survey can be repeated automatically, e.g., after a predefined time period has lapsed (e.g., a minute, an hour, a day, etc.) or in response to receiving survey data for a survey request from any single end-user via the survey computer system.

The survey data aggregation functions 245 can be an application program hosted by the scoring computer system 214 and/or can be a submodule of the scoring application program 208.

The scoring computer system comprises an application program or program module 208 configured for computing a usability score 242, also referred to as “UX-score”, from aggregated survey data 214 of one or more application programs registered at the scoring computer system.

According to some embodiments, the score 242 for a particular application program is computed based on the user experience data obtained for similar application programs (not from the usability data of all application programs registered at the scoring computer system). For example, the scoring computer system can comprise a software program or software module 218 for performing a cluster analysis of application metadata having been aggregated for a plurality of application programs 244 owned by registered customers. The clustering is performed for identifying groups (clusters) of similar application programs 243. Only the aggregated survey data of application programs having been identified to be similar to the application program of interest are used as input for computing the usability score of the application program of interest. According to embodiments, the clustering analysis performed by module 218 is performed based on application metadata and/or customer metadata 246. The metadata allows identifying, for a particular application program of interest which is owned by a particular customer, a plurality of application programs which are similar to the application program of interest and/or which are owned by a customer which is similar to the said particular customer. Only the aggregated survey data 244 of the application programs identified by the cluster analysis module 218 are provided to the scoring application 208 and used as input for computing the score.

According to preferred embodiments, the customer metadata and/or application metadata used by the clustering module 218 is free of customer-identifying information. This may allow identifying similar application programs without risking to disclose sensitive customer-related data such as company size in association with the companies' name or address.

According to some embodiments, the scoring computer system can comprise a module or application program 238 for creating and/or modifying one or more survey templates 302, 304. The survey templates are then provided to the survey computer system 236 and stored in a survey template repository 239.

According to further embodiments, the scoring computer system comprises or is operatively coupled to a key store unit 212. The key store unit is a software and/or hardware unit configured to store a plurality of customer-specific cryptographic keys which have been created for each customer having registered at the scoring computer system individually.

For example, for each of the registered customers, a symmetric cryptographic key can be stored which acts as encryption and decryption key for customer specific data, in particular sensitive customer-specific data which would allow determining the identity of the customer (such as the name and/or address of the customer). According to other embodiments, for each of the registered customers, an asymmetric cryptographic key pair with a public encryption key and a private decryption key is created upon registration of the customer, whereby at least the private decryption key stored in the key store unit 212 such that only admin-users of the customer owning the key(s) are allowed to access and use the stored key(s). The key store unit is configured to provide the keys of a particular customer to the scoring application 208 and to any other component of the scoring computer system 214 only in case an admin user of the said customer has successfully authenticated at the key store unit, has requested an action which requires the customer's encryption or decryption key and only if the customer has not yet logged out. This may have the advantage that it is ensured that the admin uses of the different customers having registered at the scoring computer system are not able to see and/or manipulate the names of the other companies having registered at the scoring computer system. Even the technical admins of the scoring computer system 214 are not able to decrypt the customer -related encrypted data stored in the data repository 220 and hence do not know the identity of the registered customers. The technical admins have only access to the unencrypted metadata which may comprise a customer-ID, e.g., a number or random character string, but is free of any data which identifies the customer.

Each time a sensitive, encrypted information is read from the customer-specific database 222, 224, 226, the cryptographic decryption key for the currently requesting customer is determined by the key store 212 to finally decrypt the encrypted parts of the information retrieved from the database, in particular the customer's name. Likewise, every time sensitive information is to be stored in the customer-specific database 222, 224, 226, in particular the customer's name and optionally further data which could reveal the identity of the customer, the cryptographic encryption key for the currently requesting customer is determined by the key store 212 to encrypt the sensitive parts of the information to be stored into the database, in particular the customer's name.

According to some embodiments, the key store is implemented based on a HSM (hardware security module). According to other embodiments, the key store is implemented as Service, e.g., the SAP Cloud Platform Credential Store service.

The data repository 220 comprising customer-related and application program -related data can be implemented, for example, as a database management system (DBMS) which can be hosted on the scoring computer system 214 or on a database server 216 operatively coupled to the scoring computer system. According to preferred embodiments, the data repository 220 comprises multiple, customer specific sub-repositories which are isolated from each other. For example, the DBMS 220 can comprise a plurality of different databases 222, 224, 226, whereby each of the databases is assigned to exactly one of the registered customers and selectively comprises data of this particular customer and of the one or more applications owned by this customer. For example, database 222 selectively comprises data for the customer “tenant 1” represented by admin user 268, database 224 selectively comprises data for the customer “tenant 2” represented by admin user 270, and database 226 selectively comprises data for the customer “tenant 3”.

Each database comprises metadata 246, whereby the metadata comprises customer metadata and application metadata of the one or more applications owned by this customer. The customer-metadata comprises sensitive customer-specific information such as information allowing identification of the customer, e.g., the name or address of the customer. Typically, the customer identifying information is stored in the database in encrypted form, whereby preferably a customer specific encryption key was used for the encryption. The customer-metadata may comprise one or more property values being indicative of a respective property of the customer. These properties can be, for example, technical field in which the customer operates, number of employees, company size, annual profit, annual turnaround, etc. The customer metadata are preferably stored in a non-encrypted form in the customer-specific database. As the customer-specific databases are isolated from each other, no customer can see any data of another customer. The technical admin of the scoring computer system and also the score computing and clustering application programs 208 and 218 can access the non-encrypted metadata, but they do not know to which customer this metadata belongs, because customer-identifying information is stored in the database only in encrypted form.

In addition, each customer-specific database comprises, for each of one or more application programs owned by the customer, anonymized survey data which was received from the survey computer system and which is free of any information being indicative of the identity of the end-users having submitted the survey data. According to preferred embodiments, also aggregated survey data 244 having been computed by module 245 for each of the one or more application programs owned by the customer is stored in the customer-specific database.

For example, database 222 comprises metadata 246.1 related to “tenant 1” (T1) and the application program(s) T1-AP1, T1-AP2 owned by “tenant 1”. In addition, it comprises survey data 227 in respect to the application program T1-AP1 obtained in a first survey request, and comprises survey data 228 in respect to the application program T1-AP2 obtained in a further survey request.

Database 224 comprises metadata 246.2 related to “tenant 2” and the application program(s) T2-AP3, T2-AP4 owned by “tenant 2” (T2). In addition, it comprises survey data 229 in respect to an application program T2-AP3 obtained in one survey request for program T2-AP3, and comprises survey data 228.2 in respect to the application program T2-AP4 obtained in a further survey request.

Database 226 comprises metadata 246.3 related to “tenant 3” (T3) and the application program(s) T3-AP5 owned by “tenant 3”. In addition, it comprises survey data 231 in respect to an application program T3-AP5 obtained in a survey request for program T3-APS.

According to embodiments, the scoring computer system is configured so store customer related data in the data repository 220 using Client-Side Field Level Encryption with a customer-specific encryption key. This means that customer related data is stored in different fields such as “customer-name”, “customer-ID”, “customer-metadata”, “application-name”, “application-ID”, “application metadata”, “application-version”, etc. Only the content of the field “customer-name” is encrypted as it comprises customer-identifying information while the content of the other fields is stored in the data repository 220 in cleartext (unencrypted) form.

Survey data 2228, 230 and 231 of different application programs deemed to be “similar” by the cluster analysis program 218 are indicated I by identical hatchings.

According to some embodiments, the scoring computer system comprises a caching subsystem 213 which is configured to receive and temporarily store survey data in case the data repository 220 is not available, e.g., because the database server 216 is down. The caching subsystem repeatedly checks whether the data repository 220 is available again and, in this case, automatically stores the cashed survey data in the sub-repository specifically assigned to the customer owning the application program whose survey data has been received and cached. This may ensure that no feedback data is lost in case the database server 216 is off-line or out of service.

The survey computer system 236 can comprise a module 241 for creating a survey-ID, for creating a survey-specific URL in response to receiving a survey request from the scoring computer system, for instantiating a survey template, for distributing the template instance to multiple end-user computers and/or for collecting the survey data obtained from the end-user computers 250, 252, 254. For example, the module 241 can be configured to create, in response to receiving a survey request for a particular application program, a QR code comprising a URL being unique to this survey. The QR code is returned to the scoring computer system to enable the scoring computer system to provide the QR code—typically via the admin user of the customer having requested the survey—to a plurality of end users. The module 241 can comprise a web server which is configured to create, upon receiving a call to the above-mentioned survey-request-specific URL, a HTML, page with a multi-page form, wherein each page comprises a plurality of questions regarding the usability of a particular application program. The web server provides the HTML page with the multipage form via a network connection to the browser of the end user computer having called the survey-request specific URL.

The web form typically comprises 20-60 questions. According to some embodiments, the web form allows the end-user to enter a question specific score value, e.g., one out of a predefined set of different numerical values. Preferably, the end-user is enabled to select, for each of the questions of the form, a question-specific score within a range covering 3-10, preferably 5, different score values such as “0”, “1”, “2”, “3”, “4”. For example, the user may enter the question-specific score by selecting one item from a radio button group, or by selecting a check-box in a group of check-boxes allowing only a single box to be selected. The form may enable the end-user to navigate between the different pages. The that form preferably comprises a survey-request-ID which is returned, together with the survey data entered by the end-user once the end-user submits the filled-out form. The survey-request-ID enables the survey computer system to identify the survey request to which the received survey data needs to be assigned. The survey computer system sends the survey data received from each of the end-user computers in Association with the survey request ID to the scoring computer system.

According to preferred embodiments, the survey computer system is configured to analyze the survey data before the data is sent to the scoring computer system. This means that any information being indicative of the identity of the end-user or end-user computer having provided the survey data (such as the IP address, place and/or time of survey data submission, etc.) is removed from the survey data.

Preferably, the survey computer system does not store the survey data permanently or is configured to delete the survey data after a predefined time, e.g., some hours, days or weeks, after having sent the survey data to the scoring computer system.

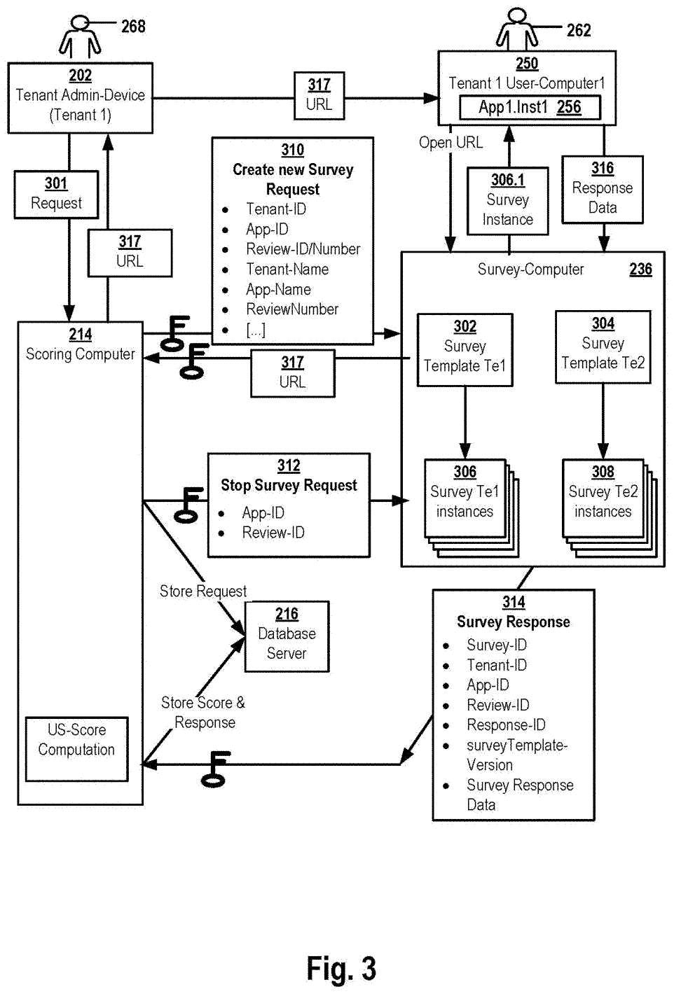

FIG. 3 is a block diagram of a distributed computer system according to embodiments of the invention. FIG. 3 illustrates the data flow between various components of the distributed computer system. The computer system can be, for example, the computer system 200 depicted in FIG. 2.

The scoring computer system 214 can comprise an interface which enables an admin user 268 of a registered customer referred herein as “tenant 1” (T1) to submit a request 301 indicating that a survey should be started in order to compute a score for the user experience of a plurality of end-users with a particular application program, e.g., application program T1-AP1. The application program T1-AP1 may not be the only application program owned by the customer T1, so the request 301 may comprise the name or an identifier of the application program of interest. The application program name can be the official name of the application program and the application-ID can be a numerical value or a random character string created by the scoring computer system upon registration of the application program T1-AP1 for the customer T1.

In response to receiving the request 301, the scoring computer system identifies at least the application-ID of the application of interest. Optionally, further parameters are identified which can be of relevance in the context of the new survey request, e.g., the customer-ID, the version number of the application program, etc. Preferably, the following steps are performed by the scoring computer system 214 only in case the admin-user 268 has successfully authenticated at the scoring computer system before or while submitting the request 301.

The scoring computer system creates a “create new survey request” 310 comprising at least the application-ID of the application program whose user experience score is to be compute. In addition, the request can optionally comprise the name of the application program, the version number, the customer-ID (referred to as “tenant-ID”), a review number to indicate the number of times the customer requested a survey of this particular application program, etc. According to preferred embodiments, the “create new survey request” 310 is free of customer-identification data, so the survey computer system does not know for which customer/company the survey is to be conducted. This greatly increases the security, because in case the request 310 should be disclosed to an unauthorized party, no sensitive information would be revealed. In addition, according to preferred embodiments, the data exchange between the scoring computer system and the survey computer system 236 is performed via a cryptographically secured communication channel, as indicated by the key symbols in FIG. 3. For example, the cryptographically secured communication channels can be HTTPS connections using SSL/TLS handshake protocol or can be based on other cryptographic protocols.

In response to receiving the request 310, the survey computer system creates a survey request ID. The survey request ID is unique for the requested survey. The survey computer system is configured to store the request 310 or at least the application-program ID is comprised in the request 310 in association with the request-ID. In addition, the survey computer system creates a URL 317 which is unique for this survey request. The URL comprises an address via which a plurality of end-user computers can obtain a survey template instance with data input means for providing survey data to the survey computer system. For example, the URL can be an http or https Internet address via which a web-form can be opened in a web-browser.

The survey computer system 236 is configured to send the URL 317 together with the request-ID to the scoring computer system 214.

According to some embodiments, the survey computer system or the scoring computer system is configured to encode the URL in a graphical code, in particular a 2D code such as a barcode, or a matrix code, e.g., a QR code. According to other embodiments, the survey computer system only provides the URL to the scoring computer system and the graphical code is created by the scoring computer system or by the computer system of the admin-user having requested the survey.

Then, the scoring computer system 214 distributes the URL to a plurality of end-users who are supposed to provide the survey feedback data. Depending on the embodiment, different distribution methods can be implemented. According to one embodiment, the scoring computer system outputs the URL as a printout which is then provided to the address of the customer T1 having requested the survey by mail. Another option is to send the URL in electronic form, e.g., by email or by an application interface, to an admin computer 202 of the customer T1. The customer T1/the admin-user 268 then distributes the URL to the end-user's which are supposed to provide the user experience data in respect to the software application of interest. For example, the admin-user 268 can may post a notice with the URL on a bulletin board in a company building, such as a cafeteria or coffee room, and invite employees to participate in the survey in the notice. The admin user can also send an email with the URL to selected employees of the company to participate in the survey. The URL can be provided as string or in the form of a 2D code.

In response to receiving a notification of the survey with the URL, a plurality of end-users 262, e.g., the employees of customer T1 having requested the survey, will access the URL 317 via their end-user devices 250 comprising a browser. The opening of the URL by the browser will trigger the survey computer system to provide an instance of a survey template to the end-user device via a network connection. For example, the survey template instance 306 can be an instance of a default survey template 302 used for acquiring user experience feedback data for a plurality of different application programs of different types.

According to embodiments, the URL comprises a parameter being indicative of the survey-ID and the survey data entered by the end-user's also comprises the survey-ID. The instantiated template integrates the survey-ID such that the survey-ID is provided by the end-users together with the survey data to the survey computer system. The survey-ID which is received by the survey computer system together with the survey data 316 enables the survey computer system to identify the survey to which the survey data belongs to.

According to some embodiments, the survey computer system comprises 2 or more different templates 302, 304 and the URL which is created in response to receiving the “create new survey request” 310 comprises a parameter which determines which ones of the survey templates is to be instantiated and distributed to the end-user computers for collecting user experience survey data 316.

According to some embodiments, the survey computer system 236 immediately forwards, upon receiving survey data 316 from any one of the end-user devices, the survey data to the scoring computer system 214. Preferably, the survey data is anonymized before it is forwarded in the form of an anonymized survey response 314 to the scoring computer system and is free of any information revealing the identity of the end-user or end-user device having submitted the survey data. The survey response 314 comprises a survey-ID and may comprise one or more further optional parameters such as the tenant-ID, the application-ID, a version-ID of the application under review, the survey template version and the survey response data.

According to other embodiments, the survey computer system pools survey data obtained from 2 or more end-user computers for the same survey and forwards the would survey data in the form of batch -wise survey responses 314 to the scoring computer system. As the survey computer system is not permitted to access the data repository 220, the survey computer system cannot store the survey data into the data repository. Rather, the scoring computer system 214 is configured to receive the survey responses 314 and store the survey data in association with the survey-ID in the data repository. For performing the storing, the scoring computer system analyzes the survey-ID and other parameters comprised in the survey response in order to identify the customer for whom the survey was conducted and for identifying the one 222 of the customer-specific databases/data sub-repositories which is specifically assigned to this customer. The survey data is stored selectively in the identified customer-specific database/data sub-repository to ensure it cannot be access by any admin-user of other customers.

According to some embodiments, the scoring computer system can send a stop survey request 312 comprising a survey-ID or other parameters allowing the identification of an ongoing survey to the survey computer system. For example, the sending of the stop survey request 312 can be triggered by the admin-user having initiated the survey to be stopped or can be triggered by the scoring computer system automatically upon determining that the predefined minimum number of end-user survey data has been received or upon determining that a predefined time period has lapsed.

The scoring computer system 214 comprises a score computation module 208 configured to compute a user experience score 242 based on the totality of survey data 314 received so far from one or more end-users having participated in the requested survey. The score can be computed after a survey was stopped or can be computed even for an ongoing survey and may be recomputed later upon receiving additional feedback data. This may have the advantage that it is not necessary to wait until a survey which may take several days or even several weeks a month was completed. Rather, it is possible to obtain a preliminary usability score already during an ongoing survey.

Then, the scoring computer system computes a graphical representation of the computed score which preferably provides a qualitative and quantitative and reproducible score for the user experience provided by the software application of interest. An example of the graphical score representation is depicted in FIG. 4.

FIG. 4 depicts a graphical representation 400 of a user experience score 242. The graphical representation of the score has the form of a pie-chart. The user experience score depicted in FIG. 4 comprises multiple (here: 12) sub-scores of multiple (here: 4) different score-categories. Each category may comprise one or many sub-scores and every sub-score is assigned to exactly one of the categories. Each of the four user-experience-categories is represented as a pie-chart-segment 402, 404, 406, 408. Each of the four segments has a unique color. For example, the segment 402 representing category “ease-of-use” can be depicted in green color, the segment 404 representing the category “utility of use” can be depicted in blue color, the segment 406 representing the category “range of use” can be depicted in orange color and the segment 408 representing the category “joy of use” can be depicted in red color.

Each segment comprises a plurality (in this case: 3) sub-segments having the same color as the segment comprising this sub-segment. For example, the sub-segments 410 “consistency” and 412 “clear structure” have the same (here: green) color as the segment 402 comprising the sub-segments 410, 412.

The radius of each of the sub-segments correlates with and/or is indicative of a respective one of the sub-scores. For example, the sub-segment 410 representing the sub-score “consistency” has a sub-score value of 3.8 and the sub-segment representing the sub-score “intuitive handling” has a sub-score value of 4.1. As a consequence, the radius of sub-segment 410 “consistency” is smaller than the radius of the sub-segment “intuitive handling”.

According to some implementations, the query template and each query form created as an instance of the template comprises a predefined number of questions for each of the sub-scores. Every question provides a predefined set of options for answering the question, e.g., enables a user to select one out of a predefined number of numerical values such as “1”, “2”, “3”, “4”, and “5”.

For each of the sub-scores, e.g., for the sub-score of the sub-category m (e.g., “consistency” 410), and for a number n of questions per sub-category m, the respective sub-score value can be computed as follows:

$$Sub - {Score}_{m} = \frac{Select . {Opt}_{Quest - m \text{.1}} + Select . {Opt}_{Quest - m \text{.2}} + Select . {Opt}_{Quest - m - 3} + … + Select . {Opt}_{Quest - m . n}}{n}$$

In an example where the user has the option to select an integer value between 1 and 5 for each of the n questions for a particular sub-category m, the sub-scoreₘ obtained from any single end-user will always be between 1.0 and 5.0.

In order to compute an aggregated sub-score sub-score_{m.agg} for sub-category m based on feedback data obtained from a number of e end-users, the following formula can be used:

$$Sub - {Score}_{m . agg} = \frac{\frac{{\sum }_{1 to {e}^{Select . Opt} Quest - m \text{.1}}}{e} + \frac{{\sum }_{1 to {e}^{Select . Opt} Quest - m \text{.2}}}{e} + … + \frac{{\sum }_{1 to {e}^{Select . Opt} Quest - m . n}}{e}}{n}$$

The user experience score may then be computed based on the aggregated sub-scores computed for the totality of sub-categories f as follows:

$$UX - {score}_{agg} = \frac{Sub - Score \text{.1} . agg + Sub - Score \text{.2} . agg + … + Sub - Score . f . agg}{f}$$

The radius for the visualization of the individual sub-scores sub-score_{1.agg}, sub-score_{2.agg}, sub-score_{f.agg} can then be calculated using the rule of three based on a given maximum radius in pixels, which corresponds to the maximum possible aggregated sub-score value for a sub-category (e.g., “5”).

Thus, the depicted graphical representation provides a reproducible, quantitative as well as qualitative indicator of user experience for a plurality of different aspects of user interaction a given application program. The complex utility score comprising a plurality of different sub-scores allows identifying strengths and weaknesses of each individual software application and allows to manually, semiautomatically or automatically improve the usability of a particular application program. For example, by comparing the graphical score representations of 2 different application programs used for inhouse vacation management, the admin user of a customer using a specific medication management software can easily determine whether the software which is used provides a better user experience than most of the other software applications used for the same or a similar purpose by similar companies.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

What is claimed is:

1. A method for computing a score for an application program, the method comprising:
providing a scoring computer system operatively coupled to a data repository, the data repository comprising registration data of multiple customers and their software applications;
providing a survey computer system comprising one or more survey templates, wherein the data repository is protected against access by the survey computer system,
receiving, by the survey computer system, a survey request from the scoring computer system, the survey request comprising an application-ID of one of the registered software applications;
providing, by the survey computer system, multiple instances of the one of the survey templates to a plurality of end-user-computers;
receiving, by the survey computer system, survey data from the plurality of end-user-computers via a network connection, the survey data being indicative of the user experience of end-users in respect to the one application program whose application-ID is comprised in the survey request, the survey data being provided in a structure defined by the template;
sending the survey data from the survey computer system to the scoring computer system, whereby the sent survey data is free of data allowing identification of individual end-users or end-user-computers; and
computing, by the scoring computer system, a score for the one application program as a function of the survey data received for at least the one application program, the score being indicative of the aggregated user experience of the end-users in respect to the one application program.

2. The method of claim 1 further comprising outputting a graphical representation of the computed score by the scoring computer system.

3. The method of claim 1, wherein the survey data received by the survey computer system comprises sensitive end-user data, in particular an IP-address and/or user-ID of the end-user-computers and wherein the method further comprises:
storing, by the survey computer system, the received survey data such that the received survey data is access protected against access by the scoring computer system; and
removing, by the survey computer system, the sensitive end-user-data from the received end-user-data for providing anonymized survey data, wherein the anonymized survey data is sent from the survey computer system to the scoring computer system.

4. The method of claim 1, wherein the computing of the score for the one application program comprises:
aggregating the totality of survey data currently comprised in the data repository which relates to the one application program and which was received via the requested survey;
automatically identifying one or more other ones of the application programs being similar to one or more application program features and/or belonging to one or more other ones of the registered customers which are similar to the customer owning the one application program; and
comparing the aggregated survey data of the one application program with the aggregated survey data of the one or more other identified application programs, wherein the score is computed as a function of the result of the comparison, whereby the score indicates the user experience of end-users in respect to the one application program relative to the user experience of end-users with the one or more identified other application programs.

5. The method according to claim 4, wherein:
the scoring computer system is configured to perform, in response to receiving survey data of one or more end-users from the survey computer system and/or in response to a repeatedly generated scheduler signal, the computing of the score;
wherein the identification of the one or more similar application programs is performed solely based on a comparison of metadata and without decrypting any customer identification data; and
wherein preferably the score computation is performed irrespective of whether the admin-user of the customer owning the one application program is currently successfully authenticated at a key store unit comprising a customer-specific cryptographic key of the said customer.

6. The method according to claim 1, wherein the data repository comprises multiple sub-repositories respectively assigned to a different one of the registered customers, whereby the data stored in the sub-repositories are isolated from each other and wherein each sub-repository comprises:
customer identification data of the customer to whom it is assigned;
application-IDs of one or more applications owned by the said customer;
application metadata of the one or more applications owned by the said customer;
customer metadata of the said customer, the customer metadata being free of information allowing identification of the said customer; and survey data gathered for the one or more application programs owned by the customer, the survey data being free of customer identification data, wherein selectively the customer identification data in each of the sub-repositories is encrypted with a customer-specific cryptographic key, and wherein the survey data and the application metadata and the customer metadata is stored in cleartext form.

7. The method according to claim 5,
wherein the scoring computer system is operatively coupled to a data storage unit referred to as key store,
wherein the customer-specific cryptographic keys are stored in the key store;
wherein the key store is configured to grant the scoring computer system access to the cryptographic key of a particular customer only after a successful authentication of an admin-user of the particular customer at the key store; and
wherein the key store is configured to deny the scoring computer system access to the cryptographic key of the particular customer automatically upon a log-out event of the admin-user from the key store.

8. The method of claim 1, further comprising:
creating, by the scoring computer system, the survey request for one of the registered customers;
in response to receiving the request, creating, by the survey-computer system, a URL being unique for the requested survey;
sending the URL from the survey-computer system to the scoring computer system; and
providing, by the scoring computer system, the URL directly or via the one of the registered customers for which the survey request was created to the end-users, in particular via a printout, an e-mail, a webpage or via an app on an end-user-device.

9. The method of claim 8,
wherein the survey computer system or the scoring computer system is configured to encode the URL in a 2D code, in particular a matrix code, and/or
wherein the survey template instance is a web-form provided via a network.

10. The method according to claim 1,
wherein the customers are companies and the data repository (220) comprises customer metadata, the customer metadata comprising one or more property values being indicative of a respective property of the customer;
wherein the data repository comprises application metadata of the application programs, the application metadata comprising one or more of: the name of the application program, the type of the application, the version of the application, the program libraries used by the application, the number of end-users to be used by the application program, the programming language of the application program, the deployment-type of the application program, the operating system required by the application program;
performing, by the scoring system, a cluster analysis for assigning the multiple application programs to different clusters, the application programs in the same cluster being similar in respect to their application metadata and/or belonging to companies being similar in respect to the customer metadata;
comparing the score of the one application program selectively with the score obtained for the ones of the application programs being in the same cluster; and
outputting a result of the cluster-specific comparison.

11. The method according to claim 1,
wherein the data repository comprises application-metadata of the application programs, the application metadata comprising one or more of: the name of the application program, the type of the application, the version of the application, the program libraries used by the application, properties of the IT-environment of the application program, the number of end-users to be used by the application program, the programming language of the application program, the deployment-type of the application program, the operating system required by the application program;
wherein the scoring computer system comprises a trained machine-learning model, the trained machine learning model having learned to correlate application metadata with respectively computed scores being indicative of end-user experience with the respective software application;
wherein the method further comprises using, by the scoring system, the trained machine learning model for predicting one or more software application modifications which will improve the end-user experience; and
outputting the predicted improvement action.

12. The method according to claim 11, wherein the predicted improvement action is selected from a group comprising:
the adding, replacement or removal of a software library;
the use of a different type or version of a DBMS used by the application program for storing or reading data;
the use of a different hardware component, in particular network interfaces, device drivers and/or data storage devices;
the use of a different webserver or application server for deploying and/or distributing the software application;
the re-programming of the software application, in particular the optimization of specific source code sections.

13. The method of claim 1, wherein the score is a combination of a set of sub-scores, each of the sub-scores belonging to one out of 2-6, preferably 4 user-experience-categories, the method further comprising creating the graphical representation of the score in the form of a pie-chart (400), wherein each of the user-experience-categories is represented as a pie-chart-segment (402, 404, 406, 408) with a unique color, each segment comprising a plurality of sub-segments having the same color as the segment comprising the sub-segment, the radius of each sub-segment being indicative of a respective one of the sub-scores.

14. The method according to claim 1, the method comprising:
in response to receiving, from any one of the multiple end-user-computers, survey data, automatically sending the received survey data from the survey computer system to the scoring computer system;
in response to receiving the survey data, re-computing, by the scoring computer system, the score as a function of the received survey data; and
outputting a graphical representation of the re-computed score by the scoring computer system.

15. The method according to claim 1, further comprising authenticating, by the scoring computer system, at the survey computer system, wherein the survey computer system is configured to process survey requests only in case the request is received from an authenticated scoring computer system.

16. The method according to claim 1, further comprising authenticating, by the survey computer system, at the scoring computer system, wherein the survey computer system is configured to receive and process survey data only in case the request is received from an authenticated survey computer system.

17. The method of claim 1, wherein at least some of the templates is customized specifically to the one of the application programs to whom it is assigned, the method further comprising:
providing, by the scoring computer system an interface enabling an admin-user of the customers to create, modify and/or delete the ones of the templates being assigned to application programs owned by respective customer;
receiving, by the scoring computer system, a newly created or modified survey template or a survey template deletion command from one of the admi-users via the interface;
sending the newly created or modified survey template or the template deletion command from the scoring computer system to the survey computer system;
updating, by the survey computer system, the survey one or more templates in accordance with the received newly created or modified survey template or the template deletion command.

18. A computer system comprising:
a scoring computer system operatively coupled to a data repository comprising registration data of multiple customers and their software applications;
a survey computer system comprising one or more survey templates, wherein the data repository is protected against access by the survey computer system, wherein the survey computer system is configured to:
receive a survey request from the scoring computer system, the survey request comprising an application-ID of one of the registered software applications;
provide, by the survey computer system, multiple instances of the one of the survey templates to a plurality of end-user-computers;
receive, by the survey computer system, survey data from the plurality of end-user-computers via a network connection, the survey data being indicative of the user experience of end-users in respect to the one application program whose application-ID is comprised I the survey request, the survey data being provided in a structure defined by the template; and
send the survey data from the survey computer system to the scoring computer system, whereby the sent survey data is free of data allowing identification of individual end-users or end-user-computers;
wherein the scoring computer system is configured to:
compute a score for the one application program as a function of the survey data received for at least the one application program, the score being indicative of the aggregated user experience of the end-users in respect to the one application program; and
output a graphical representation of the computed score.
